(19) United States
(12) Patent Application Publication
(10) Pub. No.: US 2006/0146526 A1
(43) Pub. Date: Jul. 6, 2006

(54) Flashlight

(76) Inventor: Wen-Chin Shiau, Tao-Yuan Hsien (TW)

Correspondence Address: CHRISTIE, PARKER & HALE, LLP, PO BOX 7068, PASADENA, CA, 91109-7068, US

(21) Appl. No.: 11/099,803

(22) Filed: Apr. 5, 2005

(30) Foreign Application Priority Data
Dec. 30, 2004 (TW) 093141439

(51) Int. Cl. F21L 4/04

(52) U.S. Cl. 362/205; 362/294; 362/345; 362/800; 362/373

(57) ABSTRACT

A flashlight includes a tubular housing, a module-receiving housing, an end closure, and a light emitting module. The tubular housing has opposite first and second ends. The module-receiving housing is connected to the first end of the tubular housing. The end closure is connected to the second end of the tubular housing, and is provided with a conductive urging member that extends into the tubular housing. The light emitting module is mounted in the module-receiving housing, and includes a heat dissipating member, a reflector, and a light emitting member. The heat dissipating member is in contact with the tubular housing so as to dissipate heat resulting from the light emitting member through the tubular housing.

### CROSS-REFERENCE TO RELATED APPLICATION

This application claims priority of Taiwanese application no. 093141439, filed on Dec. 30, 2004.

### BACKGROUND OF THE INVENTION

1. Field of the Invention

The invention relates to a flashlight, more particularly to a flashlight with a heat dissipating member.

2. Description of the Related Art

The lamp periphery of a conventional flashlight with an LED lamp has a tendency to soften and be damaged due to heat generated by the LED lamp when the LED lamp provides a power larger than 1 watt. Hence, there is a need to dissipate heat generated by a flashlight with a high power LED lamp.

### SUMMARY OF THE INVENTION

Therefore, the main object of the present invention is to provide a flashlight that can overcome the aforesaid drawback of the conventional flashlight.

Accordingly, a flashlight of this invention comprises a tubular housing, a module-receiving housing, an end closure, a light emitting module, and a switch.

The tubular housing has a first end and a second end opposite to the first end, and defines a first inner space that is adapted to receive a battery unit therein.

The module-receiving housing is connected to the first end of the tubular housing, and defines a second inner space therein.

The end closure is connected to the second end of the tubular housing, and is provided with a conductive urging member that extends into the first inner space in the tubular housing and that is adapted to be electrically connected to a first electrode of the battery unit.

The light emitting module is mounted in the second inner space in the module-receiving housing, and includes a heat dissipating member, a reflector that is mounted on the module-receiving housing, and a light emitting member that is disposed between the heat dissipating member and the reflector, and that is connected electrically to the urging member.

The switch is provided on the tubular housing, and is operable so as to control electrical connection between the light emitting member and a second electrode of the battery unit.

The heat dissipating member is in contact with the tubular housing so as to dissipate heat, which results from the light emitting member, through the tubular housing.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary exploded sectional view of the first preferred embodiment of a flashlight according to the present invention;

FIG. 2 is a fragmentary sectional view of the first preferred embodiment, where a switch thereof is disposed at an Off state;

FIG. 3 is an exploded perspective view of a light emitting module of the first preferred embodiment;

FIG. 4 is a fragmentary sectional view of the first preferred embodiment, where the switch thereof is disposed at an On state; and

FIG. 5 is a fragmentary exploded sectional view of the second preferred embodiment of a flashlight according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

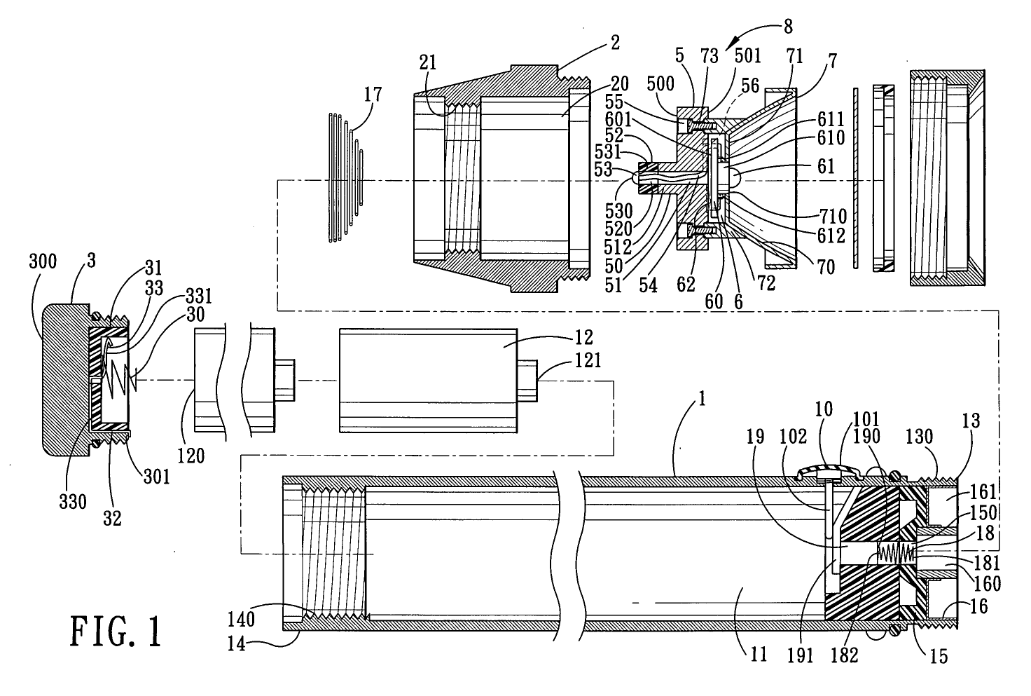

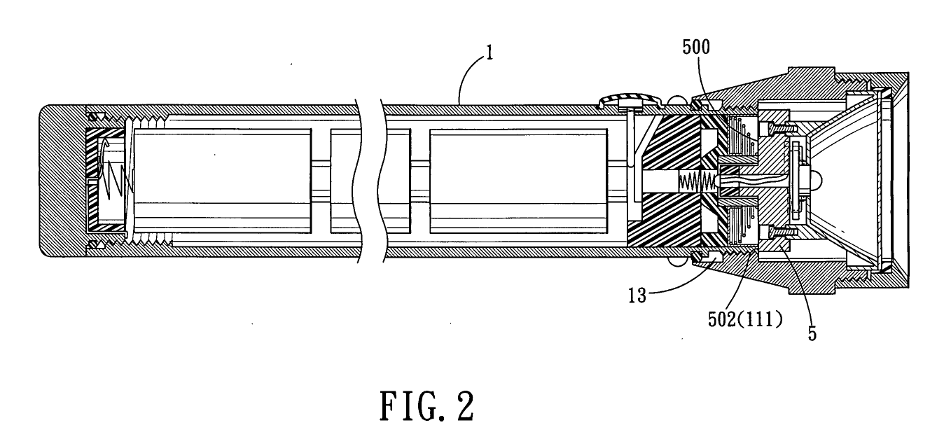

Referring to FIGS. 1 and 2, the first preferred embodiment of a flashlight according to the present invention is shown to comprise a tubular housing 1, a module-receiving housing 2, an end closure 3, and a light emitting module 8.

The tubular housing 1 is provided with a switch 10, has a first end 13 and a second end 14 opposite to the first end 13, and defines a first inner space 11 that is adapted to receive a battery unit 12 therein.

The module-receiving housing 2 is connected to the first end 13 of the tubular housing 1, and defines a second inner space 20 therein.

The end closure 3 is connected to the second end 14 of the tubular housing 1, and is provided with a conductive urging member 30 that extends into the first inner space 11 in the tubular housing 1 and that is adapted to be electrically connected to a first electrode 120 of the battery unit 12.

The light emitting module 8 is mounted in the second inner space 20 in the module-receiving housing 2, and includes a heat dissipating member 5, a reflector 7 that is mounted on the module-receiving housing 2, and a light emitting member 6 that is disposed between the heat dissipating member 5 and the reflector 7, and that is connected electrically to the urging member 30. The switch 10 on the tubular housing 1 is operable so as to control electrical connection between the light emitting member 6 and a second electrode 121 of the battery unit 12 in a manner to be described in greater detail hereinafter.

The heat dissipating member 5 is in contact with the tubular housing 1 so as to effectively dissipate heat resulting from the light emitting member 6 through the tubular housing 1 and so as to ensure safety in use of the flashlight and to lengthen the service life of the flashlight.

It should be noted herein that in order to enhance heat dissipation, each of the tubular housing 1 and the heat dissipating member 5 is made from a conductive material (in this embodiment, the heat dissipating member 5 is made from aluminum). Moreover, the heat dissipating member 5 is electrically connected to the light emitting member 6, while the tubular housing 1 is electrically connected to the urging member 30 so as to establish a circuit through the light emitting member 6.

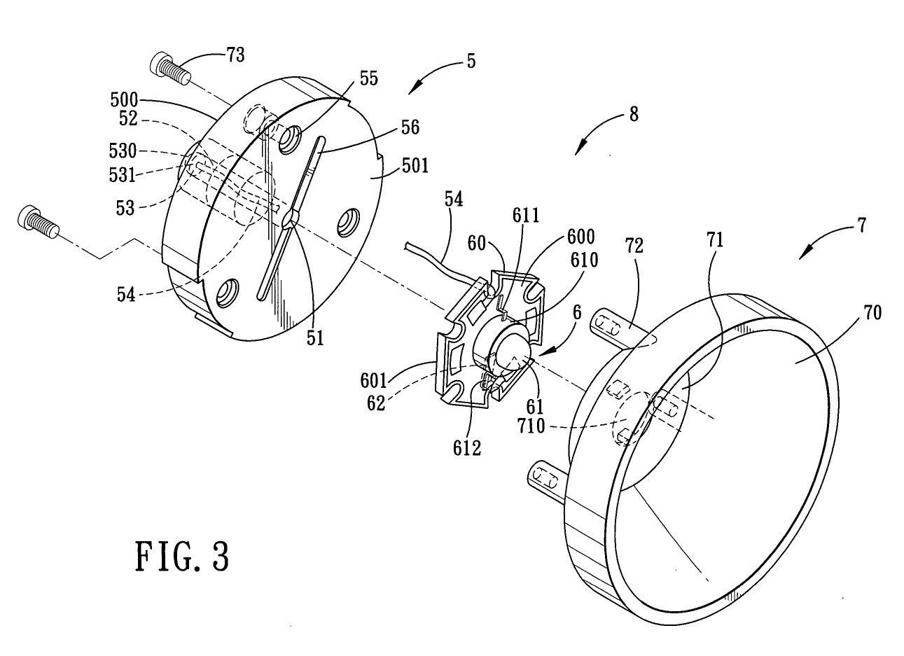

Referring to FIG. 3, the heat dissipating member 5 is formed with a plurality of positioning holes 55. The reflector 7 includes a cup-shaped housing 70 that is formed with a plurality of positioning posts 72 aligned respectively with the positioning holes 55 in the heat dissipating member 5. The light emitting module 8 further includes a plurality of fasteners 73 that extend through the positioning holes 55 and into the positioning posts 72, respectively, so as to fasten the heat dissipating member 5 to the reflector 7.

The heat dissipating member 5 has a first side 500 formed with a stud 50 that projects therefrom and that has a free end 512, and a second side 501 opposite to the first side 500. The heat dissipating member 5 is formed with a central hole 51 that extends through the stud 50 from the free end 512 of the stud 50 to the second side 501 of the heat dissipating member 5. The light emitting module 8 further includes an insulator 52 that is connected to the free end 512 of the stud 50 and that is formed with a mounting hole 520 in spatial communication with the central hole 51, and a conductive body 53 that is mounted in the mounting hole 520 in the insulator 52. The conductive body 53 has a first conductive end 530 that extends outwardly of the mounting hole 520 in the insulator 52, and that is adapted to be connected electrically to the second electrode 121 of the battery unit 12, and a second conductive end 531 opposite to the first conductive end 530. The heat dissipating member 5 further has a conductive wire 54 extending from the second conductive end 531 of the conductive body 53 through the central hole 51 toward the light emitting member 6. The second side 501 of the heat dissipating member 5 is formed with a groove 56 distal from the stud 50 and in spatial communication with the central hole 51.

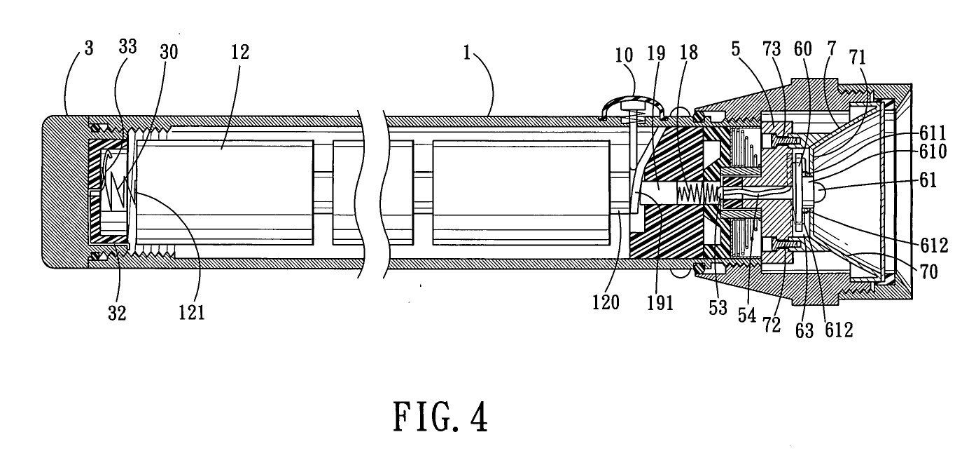

The light emitting module 8 further includes a mounting disc 60 having a first face 600 distal from the stud 50 of the heat dissipating member 5, and a second face 601 opposite to the first face 600. The light emitting member 6 includes a high-power light emitting diode (LED) lamp 61 mounted on the first face 600 of the mounting disc 60. In this embodiment, the LED lamp has a power of 3 watts. The reflector 7 further has a flat mounting portion 71 disposed at a bottom of the cup-shaped housing 70. The mounting portion 71 is formed with a lamp hole 710. The light emitting member 6 further has a ring-shaped heat-isolating pad 610 sleeved on the LED lamp 61 and abutting against a periphery of the lamp hole 710. The light emitting member 6 further has a conductive plate 62 that is bent and that is mounted on the second face 601 of the mounting disc 60. The LED lamp 61 has a cathode 611 connected to the conductive wire 54, and an anode 612 connected to the conductive plate 62. During assembly, the conductive wire 54 and the conductive plate 62 are received in the groove 56, the conductive plate 62 is connected electrically to the second side 501 of the heat dissipating member 5, and the second face 601 of the mounting disc 60 is seated on and abuts against the second side 501 of the heat dissipating member 5 so as to enhance heat dissipation of the heat resulting from the light emitting member 6. It is noted herein that, in design, the tubular housing 1 has an outer threaded portion 130, and the module-receiving housing 2 has an inner threaded portion 21 that is aligned with the outer thread portion 130 such that, after assembly, the first side 500 of the heat dissipating member 5 has a periphery 502 that abuts against a periphery 111 of the first end 13 of the tubular housing 1 so as to permit heat dissipation through the tubular housing 1, as best shown in FIG. 2. The mounting disc 60 cooperates with the mounting portion 71 to form a space 63 therebetween (see FIG. 4).

Referring again to FIGS. 1 and 2, the switch 10 includes an operating portion 101 mounted on an outer surface of the tubular housing 1, and an insulator rod 102 extending from the operating portion 101 in a radial direction toward an axis of the tubular housing 1.

The tubular housing 1 further includes an insulator base 15, a positioning seat 16, an urging component 17, a conductive biasing member 18, and a conductive component 19.

The insulator base 15 is fixedly mounted in the first end 13 of the tubular housing 1 between the battery unit 12 and the heat dissipating member 5, and is formed with a base hole 150.

The positioning seat 16 is mounted in the first end 13 of the tubular housing 1, abuts against the insulator base 15, and is formed with a central seat hole 160 in spatial communication with the base hole 150, and a peripheral seat hole 161 surrounding the central seat hole 160.

The urging component 17 is received in the peripheral seat hole 161 for urging the heat dissipating member 5 toward the light emitting member 6.

The conductive biasing member 18 is disposed in the base hole 150, and has a first end 181 abutting against the conductive body 53 of the light emitting module 8, and a second end 182 opposite to the first end 181.

The conductive component 19 is disposed in the base hole 150, and has a first end 190 connected to the second end 182 of the conductive biasing member 18, and a second end 191 opposite to the first end 190 and disposed outwardly of the base hole 150.

The insulator rod 102 of the switch 10 is operable to move between a first position (see FIG. 2), where the insulator rod 102 separates the second end 191 of the conductive component 19 from the second electrode 121 of the battery unit 12 against the urging force of the conductive biasing member 18, and a second position (see FIG. 4), where the urging force of the conductive biasing member 18 urges the second end 191 of the conductive component 19 to contact the second electrode 121 of the battery unit 12.

The end closure 3 has a first end portion 300 and a second end portion 301 opposite to the first end portion 300 and formed with a retaining space 31 toward the first end portion 300. The end closure 3 further includes a concave insulator member 32 retained in the retaining space 31, and a conductive piece 33 disposed between the insulator member 32 and the first end portion 300. The conductive piece 33 has a first segment 330 mounted on a periphery of the second end portion 301 for contacting the second end 14 of the tubular housing 1, and an opposite second segment 331 extending from the first segment 330 into the retaining space 31.

The conductive urging member 30 is connected to the second segment end 331 of the conductive piece 33, and urges the first electrode 120 of the battery unit 12.

Preferably, the second end 14 of the tubular housing 1 has an inner threaded portion 140 for threadedly engaging the end closure 3.

In operation, as shown in FIG. 4, when the switch 10 is operated to move the insulator rod 102 to the second position, the second electrode 121 of the battery unit 12 is brought into contact with the second end 191 of the conductive component 19, which results in a closed electrical circuit from the second electrode 121 of the battery unit 12 to the first electrode 120 through the conductive biasing member 18, the conductive body 53, the conductive wire 54, the cathode 611 of the LED lamp 61, the anode 612, the heat dissipating member 5, the tubular housing 1, the conductive piece 33, and the urging member 30, which, in turn, results in activation of the LED lamp 61. When the switch 10 is operated to move the insulator rod 102 back to the first position, as shown in FIG. 2, the second electrode 121 of the battery unit 12 is disconnected from the second end 191 of the conductive component 19, which results in deactivation of the LED lamp 61.

By virtue of the heat dissipating member 5, heat generated by the LED lamp 61, which accumulates in the space 63, can be effectively dissipated through the tubular housing 1, thereby preventing the light emitting module 8 from being damaged by the heat.

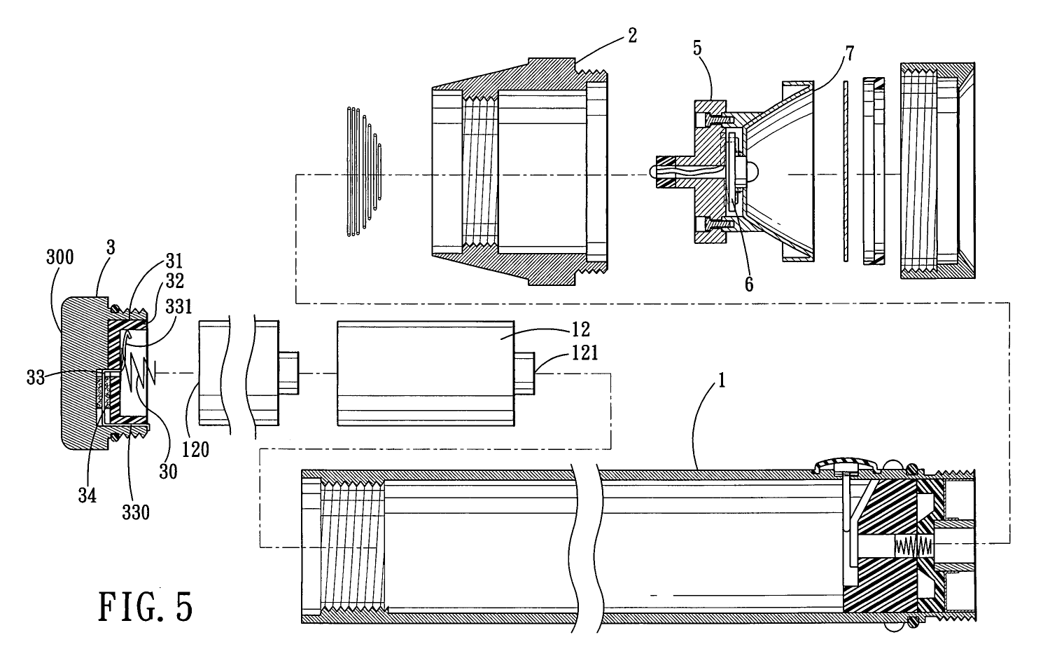

FIG. 5 illustrates the second preferred embodiment of the flashlight according to this invention. The flashlight of this embodiment differs from the previous embodiment in that a cement resistor 34 is disposed between and interconnects the first and second segments 330, 331 of the conductive piece 33 for eliminating undesired flashing which is a result of unstable current when the light emitting member 6 is activated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A flashlight comprising:
a tubular housing having a first end and a second end opposite to said first end, and defining a first inner space that is adapted to receive a battery unit therein;
a module-receiving housing connected to said first end of said tubular housing and defining a second inner space therein;
an end closure connected to said second end of said tubular housing and provided with a conductive urging member that extends into said first inner space in said tubular housing and that is adapted to be electrically connected to a first electrode of the battery unit;
a light emitting module mounted in said second inner space in said module-receiving housing and including a heat dissipating member, a reflector that is mounted on said module-receiving housing, and a light emitting member that is disposed between said heat dissipating member and said reflector, that is controlled by said switch so as to be adapted to be connected electrically to a second electrode of the battery unit, and that is connected electrically to said urging member; and
a switch provided on said tubular housing and operable so as to control electrical connection between said light emitting member and a second electrode of the battery unit;
wherein said heat dissipating member is in contact with said tubular housing so as to dissipate heat, which results from said light emitting member, through said tubular housing.

2. The flashlight as claimed in claim 1, wherein each of said tubular housing and said heat dissipating member is made from a conductive material, said heat dissipating member being electrically connected to said light emitting member, said tubular housing being electrically connected to said urging member.

3. The flashlight as claimed in claim 2, wherein said light emitting module further includes a mounting disc, said light emitting member being mounted on said mounting disc, said mounting disc being seated on said heat dissipating member so as to enhance heat dissipation of the heat resulting from said light emitting member.

4. The flashlight as claimed in claim 3, wherein said heat dissipating member is formed with a plurality of positioning holes, said reflector including a cup-shaped housing that is formed with a plurality of positioning posts aligned respectively with said positioning holes, said light emitting module further including a plurality of fasteners that extend through said positioning holes and into said positioning posts, respectively, so as to fasten said heat dissipating member to said reflector.

5. The flashlight as claimed in claim 4, wherein said heat dissipating member is formed with a stud that projects therefrom and that has a free end, and a central hole that extends through said stud, said light emitting module further including an insulator that is connected to said free end of said stud and that is formed with a mounting hole in spatial communication with said central hole, and a conductive body that is mounted in said mounting hole in said insulator, that extends outwardly thereof, and that is adapted to be connected electrically to the second electrode of the battery unit.

6. The flashlight as claimed in claim 5, wherein said cup-shaped housing of said reflector is formed with a lamp hole, said heat dissipating member being formed with a groove distal from said stud and in spatial communication with said central hole, said heat dissipating member having a conductive wire extending from said conductive body through said central hole, said mounting disc having a first face distal from said stud of said heat dissipating member, and an opposite second face, said light emitting member having a conductive plate, a light emitting diode lamp mounted on said first face of said mounting disc, and a ring-shaped heat-isolating pad sleeved on said light emitting diode lamp, said light emitting diode lamp having a cathode connected to said conductive wire, and an anode connected to said conductive plate, said conductive wire and said conductive plate being disposed in said groove in said heat dissipating member.

7. The flashlight of claim 5, wherein said switch includes an operating portion mounted on said tubular housing, and an insulator rod extending from said operating portion in a radial direction toward an axis of said tubular housing,
said tubular housing further including
an insulator base fixedly mounted in said first end of said tubular housing, and formed with a base hole,
a positioning seat mounted in said first end of said tubular housing and abutting against said insulator base, said positioning seat being formed with a central seat hole in spatial communication with said base hole, and a peripheral seat hole surrounding said central seat hole,
an urging component received in said peripheral seat hole for urging said heat dissipating member,
a conductive biasing member disposed in said base hole, and having a first end abutting against said conductive body, and a second end opposite to said first end, and
a conductive component disposed in said base hole, and having a first end connected to said second end of said conductive biasing member, and a second end opposite to said first end,
wherein said insulator rod is operable to move between a first position, where said insulator rod separates said conductive component from the second electrode of the battery unit, and a second position, where said conductive component is brought into contact with the second electrode of the battery unit by the urging force of said conductive biasing member.

8. The flashlight of claim 1, wherein said end closure has a first end portion and an opposite second end portion, said end closure being formed with a retaining space, said end closure including a concave insulator member retained in said retaining space, and a conductive piece having a first segment mounted on a periphery of said second end portion of said end closure and in contact with said second end of said tubular housing, and an opposite second segment extending from said first segment into said retaining space, said conductive urging member being connected to said second segment of said conductive piece.

9. The flashlight of claim 8, wherein said end closure further includes a cement resistor disposed between and interconnecting said first and second segments of said conductive piece.
